(19) United States
(12) Patent Application Publication
(10) Pub. No.: US 2025/0144549 A1
(43) Pub. Date: May 8, 2025

(54) FILTER, ADAPTER, AND MICROVOLUME ULTRAFILTRATION BOTTLE

(71) Applicant: HUNAN DEMETER INSTRUMENTS CO., LTD., Changsha (CN)

(72) Inventors: Feng WANG, Changsha (CN); Youzhi XIE, Changsha (CN); Tianjin XIE, Changsha (CN)

(21) Appl. No.: 19/017,318

(22) Filed: Jan. 10, 2025

Related U.S. Application Data
(63) Continuation of application No. PCT/CN2024/123243, filed on Oct. 4, 2024.

(30) Foreign Application Priority Data
Oct. 24, 2023 (CN) 2023228585720

(51) Int. Cl. B01D 29/56; B01D 29/05; B01D 29/15; B01D 35/30; B01D 61/14; G01N 1/40

(52) U.S. Cl. CPC B01D 29/56; B01D 29/05; B01D 29/15; B01D 35/306; B01D 61/145; G01N 1/4077; G01N 2001/4088

(57) ABSTRACT

The present disclosure provides a filter, an adapter, and a microvolume ultrafiltration bottle. The filter comprises a tubular structure that penetrates vertically. The inner wall of the tubular structure gradually converges from top to bottom towards the centerline to form an inverted tapered inner cavity structure, with a tapered hole at the bottom of the inverted tapered inner cavity structure. A filter disc connection part is arranged at the lower end of the tubular structure, and a bottom flow guiding channel or bottom flow guiding zone is arranged between the tapered hole and the filter disc connection part. The inner wall of the lower end of the adapter is connected with the filter. The microvolume ultrafiltration bottle comprises a bottle body and the adapter arranged at the bottle mouth and extending downwards into the bottle body, with the filter connected with the bottom of the adapter.

### CROSS-REFERENCE TO RELATED APPLICATIONS

This application is a continuation of International Application No. PCT/CN2024/123243, filed on Oct. 4, 2024, which claims priority to Chinese Patent Application No. 2023228585720, filed on Oct. 24, 2023. All of the aforementioned applications are incorporated herein by reference in their entireties.

### TECHNICAL FIELD

The present disclosure relates to the field of pretreatment devices for trace liquid samples, and specifically relates to a filter, an adapter, and a microvolume ultrafiltration bottle used for pretreatment of trace liquid samples.

### BACKGROUND

In the field of analysis and testing, trace liquid samples such as serum, plasma, urine, saliva, cerebrospinal fluid, tears, and digestive fluids are sometimes collected during a sample collection process for testing. Due to small volume and low sample concentration, trace liquids are difficult to collect and test.

It is often difficult to achieve effective mixing of samples using an existing device for pretreatment of fluid samples, and after reaction, the samples need to be separated and transferred through centrifugation and other methods. Typically, the samples are added to a solid-liquid separator to achieve solid-liquid separation by applying external pressure or relying on the gravity of the liquid itself dynamically. Or, the samples can be centrifuged using a centrifuge to achieve solid-liquid separation. However, centrifuges occupy a large volume, and the space for placing instruments in some automated analysis equipment is limited. Thus, centrifuges cannot be mounted inside the automated analysis equipment, and centrifugal separation must be performed outside the equipment before sample analysis.

The existing pretreatment of samples may cause significant losses, and may result in insufficient sample volume, decreased fidelity of metabolites, and decreased homogeneity between samples for trace liquids that are difficult to collect, leading to significant deviations in analysis results.

The applicant has focused on the research of solid-liquid separation in sample pretreatment for many years. The applicant's first-generation products are two solid-liquid separation devices, one is a sandwich membrane type solid-liquid separation component and device (publication number CN216484220U), and the other is a sandwich type solid-liquid separation device (publication number CN216484219U), which both can achieve solid-liquid separation and be connected with automated analysis equipment for use. The applicant's second-generation products, such as a natural permeation solid-liquid separation device (patent application No. 202322212192X) and a solid-liquid separation filter cartridge and sleeve type solid-liquid separation device (2023222121648) (not yet publicly available online), use a natural outside-in permeation filtration method, i.e., changing an inside-out dynamic filtration method of the original solid-liquid separator (filtration device). A filter disc of the natural permeation filtration device is designed in the form of a filter cartridge extending outwards, which can effectively solve technical problems such as limited filtration area and the need for external pressure, and further simplifying the structure to reduce the volume and save materials. On this basis, the applicant has developed a third-generation product for achieving filtration of complex samples (already applied for a patent but not yet publicly disclosed online).

The applicant now intends to further develop a fourth-generation product to achieve filtration or extraction of trace liquid samples.

### SUMMARY

The present application intends to improve upon the previous work, and provides a filter, an adapter, and a microvolume ultrafiltration bottle for the pretreatment of trace liquid samples, to achieve filtration or extraction of the trace liquid samples. The filter, the adapter, and the microvolume ultrafiltration bottle of the present disclosure can achieve filtration or extraction of trace liquid samples, are simple in operation and practical, and can directly pipet the trace liquid samples for analysis.

The first technical solution of the present disclosure is:

A filter includes a tubular structure that penetrates vertically. The inner wall of the tubular structure gradually converges from top to bottom towards the centerline to form an inverted tapered inner cavity structure, with a tapered hole at the bottom of the inverted tapered inner cavity structure. A filter disc connection part is arranged at the lower end of the tubular structure, and a bottom flow guiding channel or bottom flow guiding zone is arranged between the tapered hole and the filter disc connection part.

Preferably, at least one second sealing rib is arranged on the outer wall of the tubular structure, and is used for tight connection between the filter and the external adapter.

Preferably, upward extending grooves are formed at both ends of the filter disc connection part. The depth of the grooves extending upwards is designed according to the volume of a sample to be filtered, and the grooves may be long or short, wide or narrow. The volume of the grooves extending upwards determines the volume of the sample that can be measured, and if the sample volume is very small, an upward extending groove is not needed.

Preferably, a plurality of sidewall flow guiding channels are arranged on the outer wall of the inverted tapered inner cavity structure and used for flow guiding.

Preferably, the cross-sectional width of the tapered hole is less than the cross-sectional width of the bottom flow guiding zone, and the cross-sectional width of the bottom flow guiding zone is less than the cross-sectional width of the filter disc connection part, which is conducive to flow guiding.

Preferably, a filter disc is arranged in the filter disc connection part and is used for solid-liquid separation and filtration.

Preferably, filter discs or filter cartridges are arranged in the filter disc connection part and the upward extending grooves, the filter discs or filter cartridges are connected with the outer wall of the inverted tapered inner cavity structure, the sidewall flow guiding channels are arranged between the outer wall and the filter discs or filter cartridges, and the sidewall flow guiding channels are communicated with the bottom flow guiding channel or the bottom flow guiding zone. A sample to be tested first enters the sidewall flow guiding channels through the filter discs or filter cartridges, then enters the bottom flow guiding channel, and finally enters the interior of the filter through the tapered hole.

The material of the adapter is ABS, PP, PE, LCP, PA, PC, PPS, PFA, PEP, PEEK, or glass. The material of the filter discs or filter cartridges is PE, PP or resin fiber, with a wall thickness of 0.2-5 mm. The diameter of the filter cartridges is 2-50 mm, and the aperture of the filter cartridges is 0.2-50 μm.

The second technical solution of the present disclosure is:

An adapter includes an internally hollow tubular body, and the inner wall of the lower end of the tubular body is connected with the aforementioned filter.

Preferably, an annular groove, a first connecting section, an interference liquid receiving groove, a second connecting section, and a third connecting section are sequentially arranged from top to bottom on the outer wall of the adapter.

Preferably, at least one first sealing rib is arranged on the outer wall of the first connecting section, the second connecting section, and/or the third connecting section, and is used for sealing the adapter with the external bottle body.

The third technical solution of the present disclosure is:

A microvolume ultrafiltration bottle includes a bottle body and further includes an adapter arranged at the bottle mouth of a sample bottle and extending downwards into the bottle body, with a filter connected with the bottom of the adapter, wherein the adapter and the filter are as mentioned above.

Preferably, the first connecting section of the adapter is connected with the inner wall of the bottle mouth of the bottle body, the annular groove is above the bottle mouth, the outer walls of the second connecting section and the third connecting section are connected with the inner wall of the bottle body, and the inner wall of the third connecting section is connected with the filter. Compared with the prior art, the present disclosure has the following advantages:
1. The filter of the present disclosure has a unique design, and the tapered inner cavity of the filter is an inverted tapered inner cavity structure suitable for treatment of trace liquid samples, making the liquid level of trace liquids as high as possible, and facilitating entrance of an external sampling probe to pipet a sample to be tested.
2. The microvolume ultrafiltration bottle of the present disclosure uses an outside-in filtration method, omits the steps of transferring liquid, applying external pressure and the like required by dynamic filtration, can achieve solid-liquid separation of target substances and tangible components in protein mixtures or other samples, and can also be directly sampled and used with a sampling device of automated analysis equipment, which greatly improves the efficiency of sample pretreatment, reduces the use of auxiliary equipment, and lowers treatment costs.
3. The top of the adapter of the present disclosure is a bottle cap, and a cross slot is opened in the middle to facilitate direct penetration of a sampling probe of an analytical instrument into the bottle for sample pipetting. A plurality of grooves around the bottle cap are breathable grooves to prevent the cross slot in the middle from being blocked by fingers pressing on the top of the cap during manual use, resulting in inconsistent internal and external air pressure and preventing liquid from penetrating. The sidewall structure of the adapter of the present disclosure can be well matched with the bottle body.
4. The adapter of the present disclosure is provided with the sealing ribs, and a good sealing effect can be achieved through the sealing ribs being in close contact with the inside of a sample bottle. The sealing ribs not only have a sealing effect, but also apply positive pressure in the bottle by virtue of good sealing performance. By slowly pressing downwards through a bottle stopper, the pressure inside the bottle increases, thereby promoting a mixed liquid to penetrate from the outside of the filter cartridges into the inside. A pressure increasing technique is achieved, while the sealing and pressure increasing effects can be controlled by increasing or decreasing the number of the sealing ribs, without the need for additional pressure equipment.

The detailed structure of the present disclosure will be further described in conjunction with the accompanying drawings and specific embodiments.

### BRIEF DESCRIPTION OF FIGURES

FIG. 1 is a schematic diagram of the three-dimensional structure of a microvolume ultrafiltration bottle;

FIG. 2 is a cross-sectional view of a microvolume ultrafiltration bottle of Example 1;

FIG. 3 is a perspective view of an adapter of Example 1;

FIG. 4 is a cross-sectional view of the adapter of Example 1;

FIG. 5 is a perspective view of a filter of Example 1;

FIG. 6 (a) is a bottom view of the filter of Example 1;

FIG. 6 (b) is a cross-sectional view of the filter of Example 1;

FIG. 6 (c) is a top view of the filter of Example 1;

FIG. 6 (d) is a perspective view of the filter of Example 1;

FIG. 7 is a cross-sectional view of a microvolume ultrafiltration bottle of Example 2;

FIG. 8 is a perspective view of a filter of Example 2;

FIG. 9 (a) is a cross-sectional view of the filter of Example 2;

FIG. 9 (b) is a top view of the filter;

FIG. 9 (c) is a perspective view of the filter of Example 2;

FIG. 10 is a cross-sectional view of a microvolume ultrafiltration bottle of Example 3;

FIG. 11 is a perspective view of a filter of Example 3;

FIG. 12 (a) is a bottom view of the filter of Example 3;

FIG. 12 (b) is a cross-sectional view of the filter;

FIG. 12 (c) is a perspective view of the filter of Example 3,
where 1. Adapter; 1-1: Cross slot; 1-2: Breathable groove; 1-3: Annular groove; 1-4: First connecting section; 1-5: Interference liquid receiving groove; 1-6: Second connecting section; 1-7: Third connecting section; 1-8: First sealing rib;
2: Filter; 2-1: Inner wall; 2-2: Filter disc connection part; 2-3: Tapered hole; 2-4: Second sealing rib; 2-5: Bottom flow guiding channel; 2-6: Bottom flow guiding zone; 2-7: Sidewall flow guiding channel; 2-21: Groove;
3: Bottle body;
4: Filter disc or filter cartridge;

FIG. 13 is a standard curve of linezolid; and

FIG. 14 is a linear graph of linezolid.

### DETAILED DESCRIPTION

### Example 1

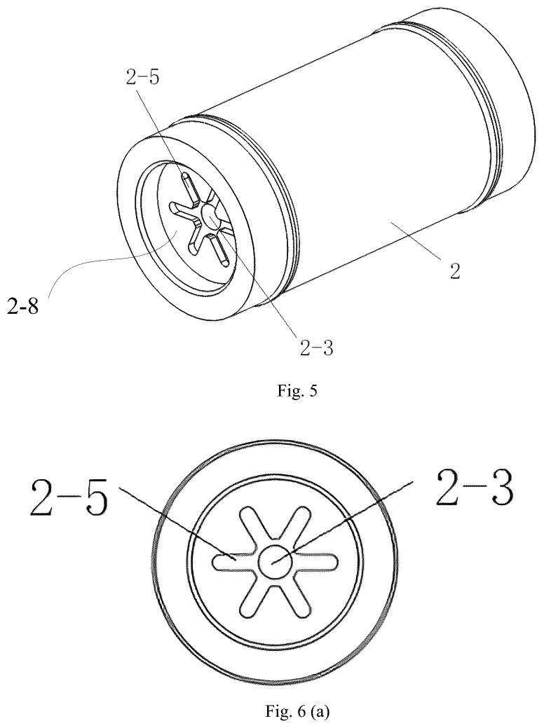

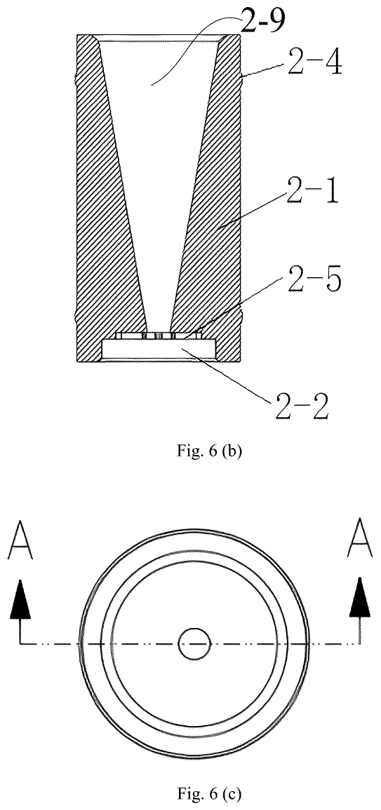

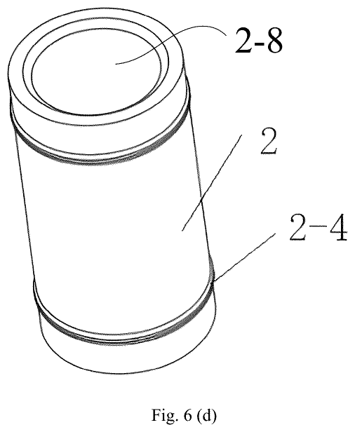

As shown in FIG. 5 to FIG. 6, a filter 2 includes a tubular structure 2-8 that penetrates vertically. The inner wall 2-1 of the tubular structure 2-8 gradually converges from top to bottom towards the centerline to form an inverted tapered inner cavity structure 2-9, with a tapered hole 2-3 at the bottom of the inverted tapered inner cavity structure 2-9. A filter disc connection part 2-2 is arranged at the lower end of the tubular structure 2-8, and a bottom flow guiding channel 2-5 is formed between the tapered hole 2-3 and the filter disc connection part 2-2. Two second sealing ribs 2-4 are arranged on the outer wall of the tubular structure 2-8. A filter disc 4 is arranged in the filter disc connection part 2-2.

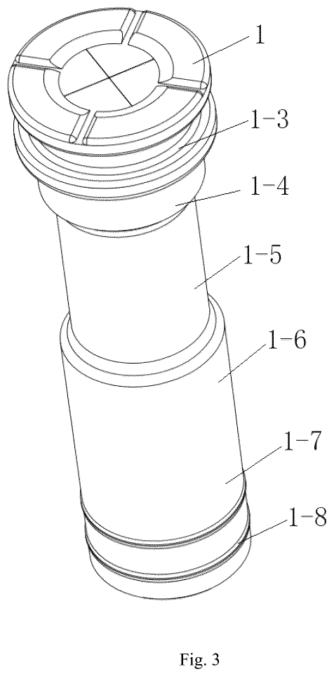

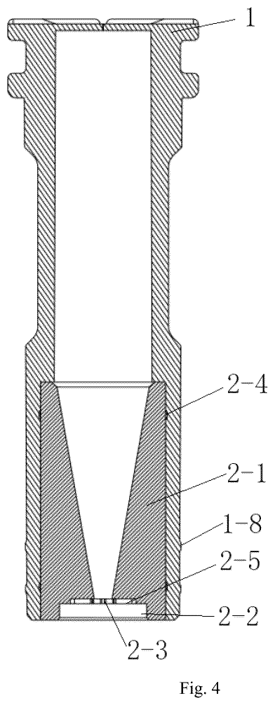

As shown in FIG. 3 to FIG. 4, an adapter 1 includes an internally hollow tubular body 1-9, and the inner wall of the lower end of the tubular body 1-9 is connected with the filter 2.

An annular groove 1-3, a first connecting section 1-4, an interference liquid receiving groove 1-5, a second connecting section 1-6, and a third connecting section 1-7 are sequentially arranged from top to bottom on the outer wall of the adapter.

Two sealing ribs 1-8 are arranged on the outer wall of the first connecting section 1-4, the second connecting section 1-6, and/or the third connecting section 1-7.

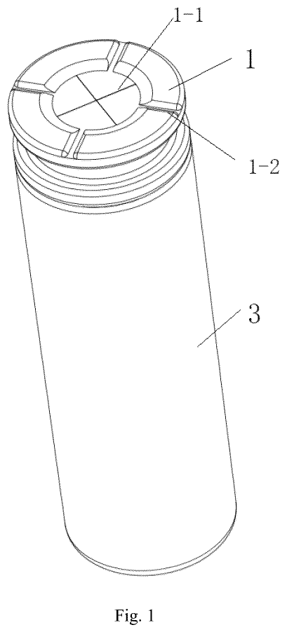

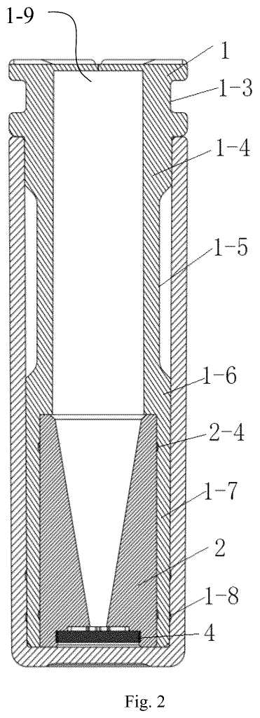

As shown in FIG. 1 to FIG. 2, a microvolume ultrafiltration bottle includes a bottle body 3, and further includes the adapter 1 arranged at the bottle mouth of a sample bottle and extends downwards into the bottle body, and the bottom of the adapter 1 is connected with the filter 2.

The first connecting section 1-4 of the adapter is connected with the inner wall of the bottle mouth of the bottle body 3, the annular groove 1-3 is above the bottle mouth, the outer walls of the second connecting section 1-6 and the third connecting section 1-7 are connected with the inner wall of the bottle body 3, and the inner wall of the third connecting section 1-7 is connected with the filter 2.

The outer diameter of the interference liquid receiving groove is smaller than the outer diameters of the first connecting section 1-4, the second connecting section, and the third connecting section. The outer diameters of the annular groove, the first connecting section 1-4, the second connecting section, and the third connecting section are smaller than the outer diameter of the adapter body.

The inner diameters of the annular groove, the first connecting section 1-4, the interference liquid receiving groove, and the second connecting section are equal, and are smaller than the inner diameter of the third connecting section.

A cap is arranged at the top of the tubular body 1-9, and the cap can be integrally formed with the tubular body 1-9 or detachably connected. A cross slot is formed in the center of the cap, and breathable grooves are formed in the upper surface of the cap.

At least one first sealing rib 1-8 is arranged on the outer wall of the first connecting section 1-4, the second connecting section 1-6, and/or the third connecting section 1-7.

The adapter 1 is a non-porous tube without porous features.

Example 1 can be used for treating trace liquid samples with a minimum volume of 10 microliters or larger.

Working principle: the bottom flow guiding channel 2-5 is arranged at the bottom of the filter 2, so liquid enters the interior of the filter 2 through the bottom flow guiding channel 2-5 and then through the tapered hole 2-3 at the bottom of the adapter 1; the filter disc is fitted in the filter disc connection part 2-2 at the bottom of the filter 2; by slowly squeezing downwards through the adapter 1, the sealing rib 1-8 on the adapter 1 and the inside of bottle 3 generate positive pressure; and the trace liquid in the bottle 3 is first filtered through the filter disc 4 and enters the bottom flow guiding channel 2-5, and then enters the inner cavity of the adapter 1 through the bottom flow guiding channel 2-5 and then through the tapered hole 2-3, to achieve the filtration or extraction of the trace liquid. A sampling device of analysis equipment directly enters the adapter and filter of the sample bottle through the cross slot in the bottle cap of the adapter of the sample bottle to pipet the liquid to be tested for subsequent analysis.

### Example 2

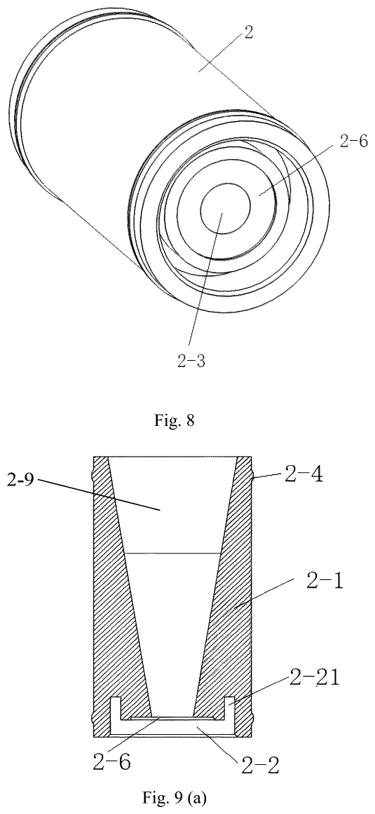

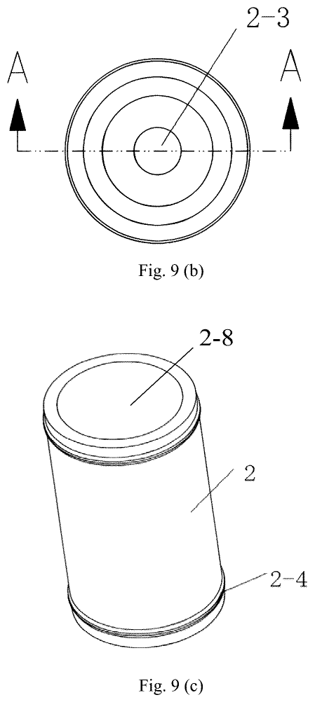

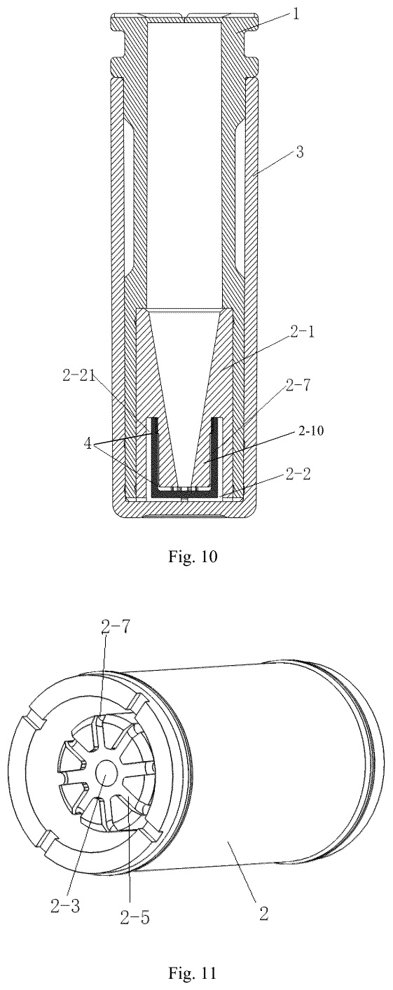

As shown in FIG. 8 to FIG. 9, a filter includes a tubular structure 2-8 that penetrates vertically. The inner wall 2-1 of the tubular structure 2-8 gradually converges from top to bottom towards the centerline to form an inverted tapered inner cavity structure 2-9, with a tapered hole 2-3 at the bottom of the inverted tapered inner cavity structure 2-9. A filter disc connection part 2-2 is arranged at the lower end of the tubular structure 2-8, and a bottom flow guiding zone 2-6 is formed between the tapered hole 2-3 and the filter disc connection part 2-2. Two second sealing ribs 2-4 are arranged on the outer wall of the tubular structure 2-8. Upward extending grooves 2-21 are formed at both ends of the filter disc connection part 2-2. The cross-sectional width of the tapered hole 2-3 is less than the cross-sectional width of the bottom flow guiding zone 2-6, and the cross-sectional width of the bottom flow guiding zone 2-6 is less than the cross-sectional width of the filter disc connection part 2-2. Filter cartridges are arranged in the filter disc connection part 2-2 and the upward extending grooves 2-21.

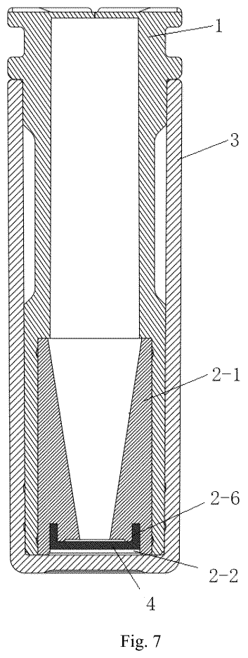

An adapter and a microvolume ultrafiltration bottle, as shown in FIG. 7, have a filter 2 different from Example 1, and the rest same as Example 1.

The device of Example 2 can be used for treating trace liquid samples with a minimum volume of 20 microliters or larger.

The working principle is the same as Example 1, except that the bottom flow guiding zone 2-6 is arranged at the bottom of the filter of Example 2. One or more filter discs can also be arranged in the bottom flow guiding zone 2-6 to form multi-stage filtration.

### Example 3

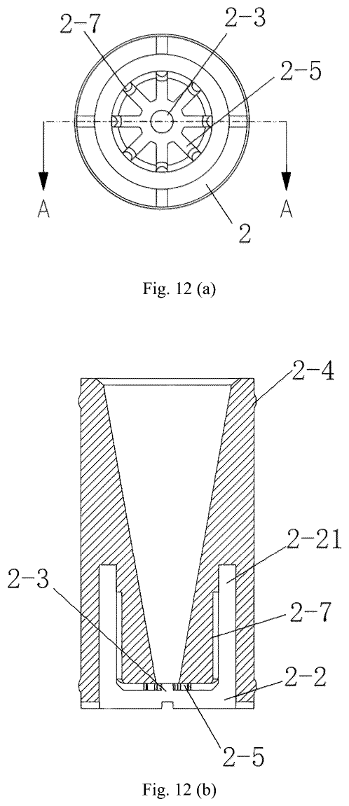

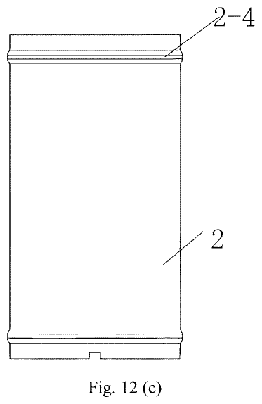

As shown in FIG. 11 to FIG. 12, a filter includes a tubular structure 2-8 that penetrates vertically. The inner wall 2-1 of the tubular structure 2-8 gradually converges from top to bottom towards the centerline to form an inverted tapered inner cavity structure 2-9, with a tapered hole 2-3 at the bottom of the inverted tapered inner cavity structure 2-9. A filter disc connection part 2-2 is arranged at the lower end of the tubular structure 2-8, and a bottom flow guiding channel 2-5 is formed between the tapered hole 2-3 and the filter disc connection part 2-2. A plurality of sidewall flow guiding channels 2-7 are arranged on the outer wall of the inverted tapered inner cavity structure 2-9.

Filter cartridges are arranged in the bottom flow guiding channel 2-5 and the upward extending grooves 2-21. The filter cartridges are connected with the outer wall of the inverted tapered inner cavity structure 2-9. The sidewall flow guiding channels 2-7 are arranged between the outer wall and the filter cartridges. The sidewall flow guiding channels 2-7 are communicated with the bottom flow guiding channel 2-5.

There are gaps between the outer sides of the filter cartridges and the grooves 2-21.

Two second sealing ribs 2-4 are arranged on the outer wall of the tubular structure 2-8.

The device of Example 3 can be used for treating trace liquid samples with a minimum volume of 50 microliters or larger.

The working principle is the same as Example 1, except that a sample to be tested first enters the sidewall flow guiding channels 2-7 through the filter cartridges, then enters the bottom flow guiding channel 2-5, and finally enters the interior of the filter 2 through the tapered hole 2-3.

Description of working process:
1. When in use, a specimen is added directly into a bottle 3 prefilled with a treatment reagent. The specimen is typically the supernatant of blood, human tissue fluid, or the like. After mixing, a sampling vial contains a solid-liquid mixture of the sample.
2. The adapter and filter (which are connected) of the sample bottle are inserted into the sample bottle 3 containing the mixed sample. The adapter is slowly pressed from top to bottom, and the sample is filtered from outside to inside through the filter and enters the tapered inner cavity of the filter and the adapter 1.
3. After standing for a period of time, solid-liquid separation of the mixed sample is achieved, and the tapered inner cavity of the filter and the adapter 1 contain transparent and clear usable liquid to be tested.
4. A sampling device of analysis equipment directly enters the adapter and filter of the sample bottle through the cross slot in the bottle cap of the adapter of the sample bottle to pipet the liquid to be tested for subsequent analysis.

According to the microvolume ultrafiltration bottle of the present disclosure, when a liquid sample comes into contact with a membrane, under a self-sealing pressure system of the sealing rib, a target substance can automatically flow through the filter material and enter the inner cavity of the adapter, thereby achieving solid-liquid separation. Moreover, a sampling probe of a chromatograph can directly sample from the inner cavity of the adapter, thereby achieving high automation. Due to the structural designs such as the sealing rib, the flow guiding channels, and the inverted tapered inner cavity of the filter of the device, the microvolume ultrafiltration bottle can maintain good sealing performance, accomplish sample pretreatment, and be compatible with and applicable to the filtration of different types of solvents, including organic solvents, such as acetonitrile and methanol reagents; strong acid and strong base solvents, such as trifluoroacetic acid and perchloric acid reagents; and neutral salt solvents, such as ammonium sulfate and zinc sulfate reagents. The existing devices on the market generally can only adapt to the filtration of organic reagents such as an acetonitrile solvent, and temporarily can achieve sampling of micro samples.

### Application Case:

A method for pretreatment using the microvolume ultrafiltration bottle of the present disclosure includes the following steps: step 1, a blood sample is centrifuged to obtain the supernatant; and step 2: the supernatant is added into the microvolume ultrafiltration bottle, allowed to stand for 5-60 s, and then directly sampled for analysis. A specific application case is as follows: linezolid in human serum is measured by the mass spectrometry method after pretreatment of samples in bottles of the present disclosure.

The instruments used in the example include a mass spectrometer (chromatograph), and the mass spectrometer (chromatograph) includes an infusion system, a sampling system, a mass spectrometric (chromatographic) separation system, a detection system, and a data processing system. The infusion system mainly includes a high-pressure infusion pump, which transports a mobile phase under high pressure during sample analysis. The sampling system mainly includes an automatic sampler, which is used to pipet a sample to be tested from a bottle after treatment. The chromatographic separation system mainly includes a chromatographic column, which separates and purifies the sample to be tested. The detection system mainly includes a chromatographic detector or mass spectrometric detector, which performs qualitative or quantitative detection of a target substance to be tested. The data processing system mainly includes a computer and workstation software, which process or analyze the results of the detection.

The instruments and equipment used in the example are from the prior art and can be purchased on the market.

### I. Chromatographic Conditions:

Mobile phase A: methanol: water=38:62, V/V, containing 0.1% formic acid;
Mobile phase B: ultrapure water

Isocratic elution: flow rate of mobile phase A: 0.6 mL/min, flow rate of mobile phase B: 0.6 mL/min, sampling volume: 1 uL, column temperature: 45° C.;

Mass spectrometric conditions: positive ion: atomization gas flow rate: 3 L/min, heating gas flow rate: 10 L/min, interface temperature: 220° C., desolvation temperature: 391° C., DL temperature: 180° C., heating block temperature: 220° C., drying gas flow rate: 10 L/min, and interface voltage: 0.6 KV.

The mass spectrometric parameters of an analyte need to be optimized before detection, and the results are shown in Table 1:

TABLE 1
Mass spectrometric conditions for substance to be tested

| | | | | | | Atomi- | Heating | Drying | Heating |
|---|---|---|---|---|---|---|---|---|---|
| | Parent | Daughter | Ion | Interface | DL | zation | block | gas | gas |
| | ion | ion | source | temper- | temper- | gas flow | temper- | flow | flow |
| Name | (m/z) | (m/z) | mode | ature | ature | rate | ature | rate | rate |
| Linezolid | 338.3 | 296.1 | ESI+ | 220° C. | 180° C. | 3 L/min | 220° C. | 10 | 10 |
| | | | | | | | | L/min | L/min |

### II. Testing Process:

### 1. Setup Solution, Internal Standard Working Fluid, Standard Curve, and Quality Control Samples for Testing are Prepared.

Setup solution: 5 μg/mL, dissolved in 50% methanol.

Method for preparing standard curve and quality controls: a standard is dissolved in pure methanol and diluted with recombinant human blood to concentration points.

TABLE 2
Concentration of standard curve prepared

| | Calibrated point | | | | | |
|---|---|---|---|---|---|---|
| | Calibration curve data (ug · mL⁻¹) | | | | | |
| | Cali- | Cali- | Cali- | Cali- | Cali- | Cali- |
| | brated | brated | brated | brated | brated | brated |
| Name | point 1 | point 2 | point 3 | point 4 | point 5 | point 6 |
| Linezolid | 0.2042 | 1.021 | 2.553 | 5.106 | 10.21 | 20.42 |

TABLE 3
Concentration of quality controls prepared

| | Quality control point | | |
|---|---|---|---|
| | Concentration of Quality control (ug · mL⁻¹) | | |
| Name | Quality control 1 | Quality control 2 | Quality control 3 |
| Linezolid | 0.6284 | 8.169 | 16.339 |

TABLE 4
Concentration of internal standard working fluid prepared

| Internal standard working fluid | Concentration |
|---|---|
| Linezolid | 12 ug/ml |

### 2. Pretreatment of Sample

A pretreatment method for samples in bottles is used: 600 ul of a sample release agent A (methanol: acetonitrile=4:1, V/V) is accurately pipetted into a sampling vial containing a freeze-dried isotope, and then 200 μl of a sample (plasma) is accurately added, placed in a pretreatment and filtering device for a sample in a bottle, allowed to stand for 30 s, and then put into an instrument for machine testing.

### 3. Quantitative Determination

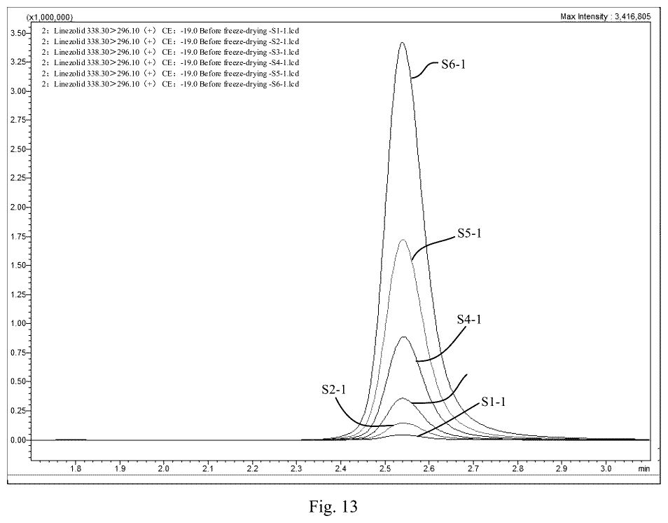

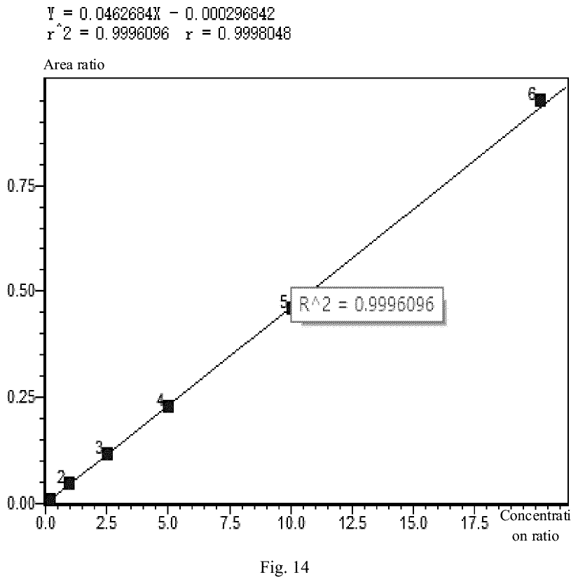

Using the internal standard method for quantification, a working curve is plotted with the ratio of the target peak area to the isotope internal standard peak area as the y-axis and concentration as the x-axis. The linear type is a straight line. The ratio of the sample peak area to the isotope internal standard peak area is substituted into the standard curve to calculate the concentration, as shown in FIG. 13 to FIG. 14.

### 4. Determination of Accuracy of Method Results

The prepared linezolid is taken, and the quality control samples at three levels of low, medium, and high concentrations are treated and measured. 6 groups of parallel samples for each concentration are set up, and the measured results are substituted into the linear regression equation to calculate the concentration. The tested concentration is compared with the theoretical added concentration. The accuracy of the quality control samples at three levels of low, medium, and high concentrations is assessed using a stable isotope internal standard quantification method.

By calculation, the accuracy of all the quality control samples at three levels of low, medium, and high concentrations is 85% to 115%, the CV values are all less than 20%, thus the treatment method has good accuracy.

TABLE 5
Accuracy of quality control of linezolid

| | Standard | | | | | | | Average | | |
|---|---|---|---|---|---|---|---|---|---|---|
| | concentration | Concentrations measured (ug/ml) | | | | | | value | Accuracy | RSD |
| Drug | (ug/ml) | 1 | 2 | 3 | 4 | 5 | 6 | (ug/ml) | % | % |
| Linezolid | 0.6284 | 0.632 | 0.634 | 0.683 | 0.657 | 0.666 | 0.646 | 0.653 | 103.9 | 3.01 |
| | 8.169 | 8.103 | 8.043 | 8.057 | 8.012 | 8.043 | 8.101 | 8.06 | 98.7 | 0.44 |
| | 16.339 | 17.21 | 17.07 | 17.11 | 16.98 | 17.18 | 16.99 | 17.09 | 104.6 | 0.56 |

### Comparative Analysis: Comparison Between the Pretreatment Method for Samples in Bottles and the Most Commonly Used and Simplest Protein Precipitation Pretreatment Method on the Market

Detailed steps of the pretreatment method for samples in bottles: step 1: a whole blood sample is centrifuged at low speed to obtain the supernatant (plasma or serum); step 2: the serum/plasma sample is added into a sample bottle of a solid-liquid separation device prefilled with a treatment reagent, and shaken well; and step 3, a separation component is inserted into the sample bottle containing the mixed sample, and allowed to stand for 5-60 s to achieve solid-liquid separation, and then sampling for analysis can be performed.

Steps of a protein precipitation pretreatment method (centrifugation using an EP tube): step 1: a whole blood sample is centrifuged at low speed to obtain the supernatant (plasma or serum); step 2: a certain amount of treatment reagent is added to a prepared EP tube; step 3: the serum/plasma sample is added into the EP tube filled with the treatment reagent, and vortexed and shaken uniformly with the cap of the EP tube covered; step 4: the EP tube vortexed and shaken uniformly is put into a high-speed centrifuge and centrifuged at high speed for 8-15 min to achieve solid-liquid separation; and step 5: the supernatant from the EP tube centrifuged at high speed to achieve solid-liquid separation is transferred into a sampling vial, and the sampling vial is put into an analytical instrument for analysis.

Steps of a protein precipitation pretreatment method (centrifugation using a 96-well plate): step 1: a whole blood sample is centrifuged at low speed to obtain the supernatant (plasma or serum); step 2: a certain amount of treatment reagent is added to a prepared 96-well plate; step 3: the serum/plasma sample is added into the 96-well plate filled with the treatment reagent, and vortexed and shaken uniformly with the 96-well plate covered; step 4: for balancing, a certain amount of water is added to another 96-well plate, weighed, and kept consistent with the other 96-well plate in weight; step 5: the 96-well plate filled with the sample and vortexed and shaken uniformly and the balanced 96-well plate are put into a special centrifuge for 96-well plates and centrifuged at low speed for 15-20 min to achieve solid-liquid separation; and step 6: the supernatant from the 96-well plate centrifuged to achieve solid-liquid separation is transferred into another clean 96-well plate or a sampling vial, and put into an analytical instrument for analysis.

TABLE 6
Comparison of results of several pretreatment methods

| | Parameter comparison | | | | | |
|---|---|---|---|---|---|---|
| | | | | | Whether | Solid-liquid |
| | | | | Con- | auxiliary | separation |
| | | | | sumption | equip- | effect |
| | Treatment | Treatment | | of | ment | (content of |
| | speed of | speed of | | con- | is | residual |
| | single | batch | Extraction | sumable | needed | protein in |
| Pretreatment | specimen | specimen | recovery | materials | or not | supernatant) |
| Pretreatment of | 1.5 | 1.5 | 92.7% | 2 kinds | 1 kind | less than1% |
| a sample in a | min/piece | min/piece | | | | |
| bottle | | | | | | |
| Protein | 12 | 5.0 | 92.2% | 3 kinds | 3 kinds | less than 1% |
| precipitation | min/piece | min/piece | | | | |
| (centrifugation | | | | | | |
| in an EP tube) | | | | | | |
| Protein | 12 | 3.0 | 90.6% | 3 kinds | 3 kinds | less than 2% |
| precipitation | min/piece | min/piece | | | | |
| (centrifugation | | | | | | |
| in a 96-well | | | | | | |
| plate) | | | | | | |

Compared with the traditional common protein precipitation pretreatment methods, the pretreatment method for samples in bottles is more effective, has fewer steps, is more convenient to use, can save some additional consumables required in the steps of the protein precipitation method, and greatly saves time and costs.

The above is the detailed description of the present disclosure, but the scope of protection of the present disclosure is not limited thereto. Equivalent replacements or changes made by any skilled person familiar with the technical field within the technical scope disclosed in the present disclosure and based on the technical solution and concept of the present disclosure, should be included in the scope of protection of the claims of the present disclosure.

What is claimed is:

1. A filter, comprising a tubular structure (2-8) that penetrates vertically, wherein the inner wall (2-1) of the tubular structure (2-8) gradually converges from top to bottom towards the centerline to form an inverted tapered inner cavity structure (2-9), with a tapered hole (2-3) at the bottom of the inverted tapered inner cavity structure (2-9); a filter disc connection part (2-2) is arranged at the lower end of the tubular structure (2-8); and a bottom flow guiding channel (2-5) or bottom flow guiding zone (2-6) is formed between the tapered hole (2-3) and the filter disc connection part (2-2).

2. The filter according to claim 1, wherein at least one second sealing rib (2-4) is arranged on the outer wall of the tubular structure (2-8).

3. The filter according to claim 1, wherein upward extending grooves (2-21) are formed at both ends of the filter disc connection part (2-2).

4. The filter according to claim 3, wherein a plurality of sidewall flow guiding channels (2-7) are arranged on the outer wall (2-10) of the inverted tapered inner cavity structure (2-9).

5. The filter according to claim 1, wherein the cross-sectional width of the tapered hole (2-3) is less than the cross-sectional width of the bottom flow guiding zone (2-6), and the cross-sectional width of the bottom flow guiding zone (2-6) is less than the cross-sectional width of the filter disc connection part (2-2).

6. The filter according to claim 1, wherein a filter disc or filter cartridge (4) is arranged in the filter disc connection part (2-2).

7. The filter according to claim 3, wherein filter discs or filter cartridges (4) are arranged in the filter disc connection part (2-2) and the upward extending grooves (2-21), the filter discs or filter cartridges (4) are connected with the outer wall (2-10) of the inverted tapered inner cavity structure (2-9), the sidewall flow guiding channels (2-7) are arranged between the outer wall (2-10) of the inverted tapered inner cavity structure (2-9) and the filter discs or filter cartridges (4), and the sidewall flow guiding channels (2-7) are communicated with the bottom flow guiding channel (2-5) or the bottom flow guiding zone (2-6).

8. An adapter, comprising an internally hollow tubular body (1-9), wherein the inner wall of the lower end of the tubular body (1-9) is connected with the filter (2) according to claim 1.

9. The adapter according to claim 8, wherein an annular groove (1-3), a first connecting section (1-4), an interference liquid receiving groove (1-5), a second connecting section (1-6), and a third connecting section (1-7) are sequentially arranged from top to bottom on the outer wall of the adapter.

10. The adapter according to claim 9, wherein at least one first sealing rib (1-8) is arranged on the outer wall of the first connecting section (1-4), the second connecting section (1-6), and/or the third connecting section (1-7).

11. A microvolume ultrafiltration bottle, comprising a bottle body (3), and further comprising the adapter (1) according to claim 8, wherein the adapter (1) is arranged at the bottle mouth of the bottle body (3) and extends downwards into the bottle body (3), and the bottom of the adapter (1) is connected with the filter (2) according to claim 1.

12. The microvolume ultrafiltration bottle according to claim 11, wherein the first connecting section (1-4) of the adapter (1) is connected with the inner wall of the bottle mouth of the bottle body (3), the annular groove (1-3) is above the bottle mouth, the outer walls of the second connecting section (1-6) and the third connecting section (1-7) are connected with the inner wall of the bottle body (3), and the inner wall of the third connecting section (1-7) is connected with the filter (2).
